(19) United States
(12) Patent Application Publication
(10) Pub. No.: US 2020/0117482 A1
(43) Pub. Date: Apr. 16, 2020

(54) DYNAMIC LOADING OF A JAVA AGENT INTO A RUNNING PROCESS THROUGH DIRECT PROCESS MEMORY MANIPULATION

(71) Applicant: CA, Inc., New York, NY (US)

(72) Inventors: Ales Lopata, Kolin (CZ); Devasia Antony Muthalakuzhy Thomas, Milpitas, CA (US)

(21) Appl. No.: 16/159,337

(22) Filed: Oct. 12, 2018

(51) Int. Cl. G06F 9/445; G06F 9/455; G06F 11/34; H04L 29/08; H04L 12/54

(52) U.S. Cl. CPC G06F 9/44521; G06F 9/45504; H04L 12/56; H04L 67/02; G06F 11/3495

(57) ABSTRACT

A method includes performing, by a processor: instantiating a first process corresponding to a first user identification and modifying a Java Runtime Environment (JRE) associated with a second process corresponding to a second user identification that is different from the first user identification to include a loader, the loader being configured to load a Java agent into the second process. Modifying the JRE comprises modifying the JRE using the first process.

### BACKGROUND

The present disclosure relates to communication systems including computer systems and networking equipment, and, more particularly, to methods, systems, and computer program products for managing computer system and communication network performance.

Computer systems may include performance management software that is designed to detect and diagnose complex software and/or hardware performance problems to maintain an expected level of service. Various types of performance metrics may be monitored: Measurements for these metrics may establish an empirical performance baseline for applications and/or hardware elements, such as servers, processors, databases, networking equipment, and the like. The baseline can then be used to detect changes in performance. Changes in performance may be correlated with external events and subsequently used to predict future changes in system performance.

It may be desirable to monitor the performance of legacy computer systems and/or networks, which are currently deployed in an enterprise. The enterprise, however, may want to avoid taking their computer systems and/or networks offline to add the additional performance monitoring software and then performing a re-boot or initialization as such a procedure may adversely impact the enterprise economically and/or the unavailability of services provided through such computer systems and/or networks may cause a significant inconvenience to the enterprise's customers. One technique for modifying a running process is through the use of agents. Agents are operating system native or Java libraries to which the Java Virtual Machine (JVM) provides capabilities that aren't available to normal application code. There are two types of agents: Java agents and native agents. Java agents are .jar files that define a special premain static function that will be invoked by the Java Virtual Machine (JVM) before the application's main function is invoked. Native agents are not written in Java, but mostly in an objected oriented programming language, such as C++, and are not subjected to the rules and restrictions under which normal Java code operates. Native agents are also provided with a set of capabilities called the JVM Tooling Interface (JVMTI). Agents may have the ability to dynamically rewrite the contents of a target class's method at run-time. This process, which is known as bytecode instrumentation, may enable the agent to essentially rewrite the contents of a method while the code is running An agent may, for example, be used to modify a target system's code to inject new code to collect performance metrics.

### SUMMARY

In some embodiments of the inventive subject matter, a method comprises, performing by a processor: instantiating a first process corresponding to a first user identification and modifying a Java Runtime Environment (JRE) associated with a second process corresponding to a second user identification that is different from the first user identification to include a loader, the loader being configured to load a Java agent into the second process. Modifying the JRE comprises modifying the JRE using the first process.

In other embodiments of the inventive subject matter, a system comprises a processor and a memory coupled to the processor that comprises computer readable program code embodied in the memory that is executable by the processor to perform operations comprising: instantiating a first process corresponding to a first user identification, modifying a JRE associated with a second process corresponding to a second user identification that is different from the first user identification to include a loader, the loader being configured to load a Java agent into the second process, the Java agent being configured to collect performance information corresponding to an entity for a performance metric, and modifying a configuration of the entity based on the performance information. Modifying the JRE comprises modifying the JRE using the first process.

In further embodiments of the inventive subject matter, a computer program product comprises a tangible computer readable storage medium comprising computer readable program code embodied in the medium that when executed by a processor causes the processor to perform operations comprising: instantiating a first process corresponding to a first user identification and modifying a JRE associated with a second process corresponding to a second user identification that is different from the first user identification to include a loader, the loader being configured to load a Java agent into the second process, the Java agent is configured to collect information corresponding to Hypertext Transfer Protocol (HTTP) requests associated with the second process. Modifying the JRE comprises modifying the JRE using the first process.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive subject matter may be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims. It is further intended that all embodiments disclosed herein can be implemented separately or combined in any way and/or combination.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram of a computing system environment configured for dynamic loading of an agent into a running process through runtime environment modification according to some embodiments of the inventive concept;

FIG. 2 is a block diagram of a communication network including a performance management system for dynamic loading of an agent into a running process through runtime environment modification in accordance with some embodiments of the inventive concept;

FIG. 3 is a block diagram that illustrates the use of software containers in accordance with some embodiments of the inventive concept;

FIG. 4 illustrates a data processing system that may be used to implement the performance management system of FIG. 2 in accordance with some embodiments of the inventive concept;

FIG. 5 is a block diagram that illustrates a software/hardware architecture for use in an a performance management system for dynamic loading of an agent into a running process through runtime environment modification in accordance with some embodiments of the inventive concept;

FIG. 6 is a block diagram that illustrates a runtime environment in accordance with some embodiments of the inventive concept; and

FIGS. 7 and 8 are flowcharts that illustrate operations for dynamic loading of an agent into a running process through runtime environment modification in accordance with some embodiments of the inventive concept.

### DETAILED DESCRIPTION

In the following detailed description, numerous specific details are set forth to provide a thorough understanding of embodiments of the present disclosure. However, it will be understood by those skilled in the art that the present invention may be practiced without these specific details. In some instances, well-known methods, procedures, components and circuits have not been described in detail so as not to obscure the present disclosure. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

As used herein, a “service” includes, but is not limited to, a software and/or hardware service, such as cloud services in which software, platforms, and infrastructure are provided remotely through, for example, the Internet. A service may be provided using Software as a Service (SaaS), Platform as a Service (PaaS), and/or Infrastructure as a Service (IaaS) delivery models. In the SaaS model, customers generally access software residing in the cloud using a thin client, such as a browser, for example. In the PaaS model, the customer typically creates and deploys the software in the cloud sometimes using tools, libraries, and routines provided through the cloud service provider. The cloud service provider may provide the network, servers, storage, and other tools used to host the customer's application(s). In the IaaS model, the cloud service provider provides physical and/or virtual machines along with hypervisor(s). The customer installs operating system images along with application software on the physical and/or virtual infrastructure provided by the cloud service provider.

As used herein, the term “data processing facility” includes, but it is not limited to, a hardware element, firmware component, and/or software component. A data processing system may be configured with one or more data processing facilities.

As used herein the term “entity” may include a hardware element, a software element, and/or an element that has one or more hardware elements and/or software elements in combination.

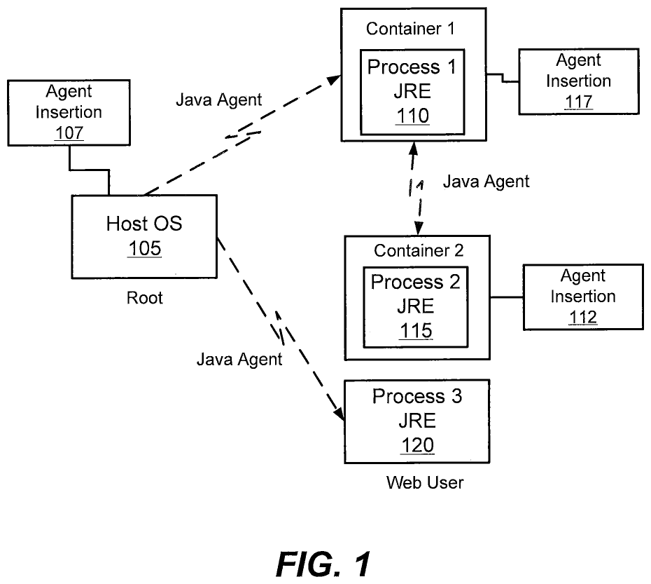

Some embodiments of the inventive concept stem from a realization that the Java Runtime Environment (JRE) provides a remote attach capability for dynamically loading a Java agent into a running process, but the remote attach capability has some limitations. For example, as shown in FIG. 1, a computing system environment may include a host Operating System (OS) 105 and three processes running under the JRE: Process 1 110, Process 2 115, and Process 3 120. To perform a remote attach of a Java agent to a running process, JRE can be signaled to open a Unix domain socket or Inter-Process Communication (IPC) socket. This socket can be used to request loading of a Java agent dynamically into a running process. There are some limitations associated with the use of sockets in the remote attach capability. As represented by the dashed arrow between the Host OS 105 and Process 3 120, loading of a Java agent through a remote attach does not work when the users are different, i.e., a Linux “Root” user or superuser may not dynamically load a Java agent into Process 3 120, which is associated with a Web user. As represented by the dashed arrow between the Host OS 105 and the Process 1 110 in Container 1, loading of a Java agent through a remote attach does not work across a container boundary, i.e., a Root user or super user may not dynamically load a Java agent into Process 1 110 across the Container 1 boundary. Similarly, as represented by the dashed arrow between the Process 1 110 and the Process 2 115, loading of a Java agent through a remote attach does not work across container boundaries, i.e., Process 1 110 in Container 1 cannot dynamically load a Java agent into Process 2 115 in Container 2 and vice versa. Embodiments of the inventive subject matter provide agent insertion modules 107, 117, and 112, which may be configured to modify the JRE of a process to include a new loader that is designed to load a Java agent into a particular process. The JRE corresponding to a second process can be modified across container boundaries to include a new loader using a first process associated with a first user, such as a superuser, e.g., root, administrator, etc. When the JRE executes the loader it will load the Java agent into the second process, which may be associated with a second user different from the first user.

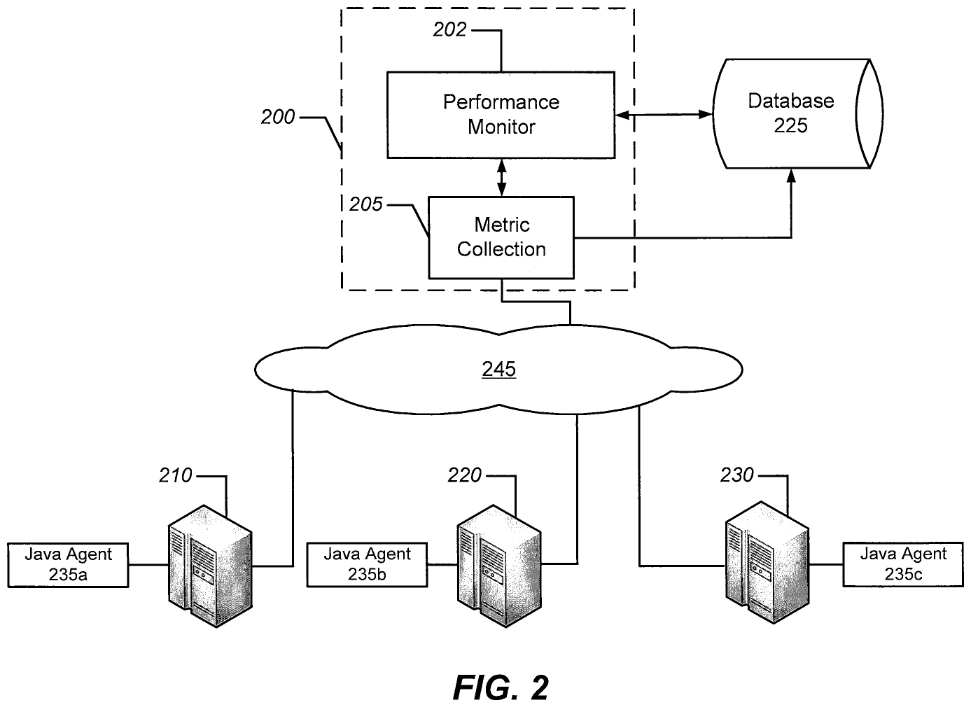

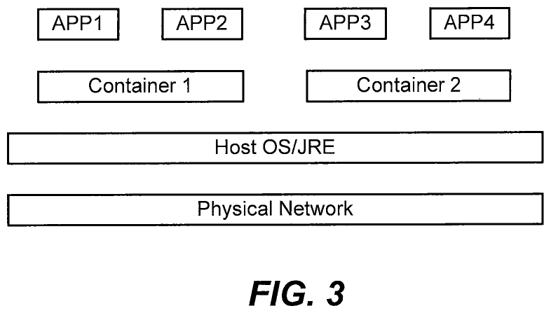

Referring to FIG. 2, a communication network including a performance management system for dynamic loading of an agent into a running process through runtime environment modification, in accordance with some embodiments of the inventive concept, comprises a performance management system 200 and servers 210, 220, and 230 coupled via a communication network 245. The network 245 may be a global network, such as the Internet or other publicly accessible network. Various elements of the network 245 may be interconnected by a wide area network, a local area network, an Intranet, and/or other private network, which may not be accessible by the general public. Thus, the communication network 245 may represent a combination of public and private networks or a virtual private network (VPN). The network 245 may be a wireless network, a wireline network, or may be a combination of both wireless and wireline networks. One or more of the servers 210, 220, 230 may represent host(s) that support one or more virtual machines. As shown in FIG. 3 a server may comprise a physical infrastructure or processing network on which a host operating system and a runtime environment, such as the JRE, may execute. Higher level software may be organized using containers. As shown in FIG. 3, software applications APP1 and APP2 are part of Container 1 and software applications APP3 and APP4 are part of Container 2. A container image is a standalone, executable package of software that includes everything needed to run an application: code, runtime, system tools, system libraries and settings. Container images become containers at runtime. Containers isolate software from its environment and ensure that it works uniformly despite differences, for example, between development environments and deployment environments.

Returning to FIG. 2, the performance management system 200, in some embodiments, may include a performance monitor 202 and a metric collection module 205. The performance management monitor 202 and/or the metric collection module 205 may be configured for implementation in whole or in part on one or more of the servers 210, 220, and 230 and/or other network equipment, such as routers, switches, application servers, and the like. The metric collection module 205 is configured to communicate with the servers 210, 220, and 230 to collect performance information from these entities for various performance metrics and to provide the information to the performance monitor 202 and/or information repository, e.g., database 225, for processing. Although three servers 210, 220, and 230 are shown, it will be understood that the performance of fewer or more entities, including other types of entities, such as hardware switches, software switches, routers, firewalls, gateways, and the like, can be managed in accordance with various embodiments of the inventive concept. In some embodiments, the performance monitor may 202 may include an agent insertion capability, which may be configured to modify the JRE of a process running on a server or other network element, for example, to include a new loader that is designed to load a Java agent into the process. Moreover, the JRE can be modified across both container and username boundaries. It will be appreciated that in accordance with various embodiments of the inventive concept, the performance management system 200 may be implemented as a single server, separate servers, or a network of servers either co-located in a server farm, for example, or located in different geographic regions.

Although FIG. 2 illustrates an exemplary communication network including a performance management system for dynamic loading of an agent into a running process through runtime environment modification, it will be understood that embodiments of the inventive concept are not limited to such configurations, but are intended to encompass any configuration capable of carrying out the operations described herein.

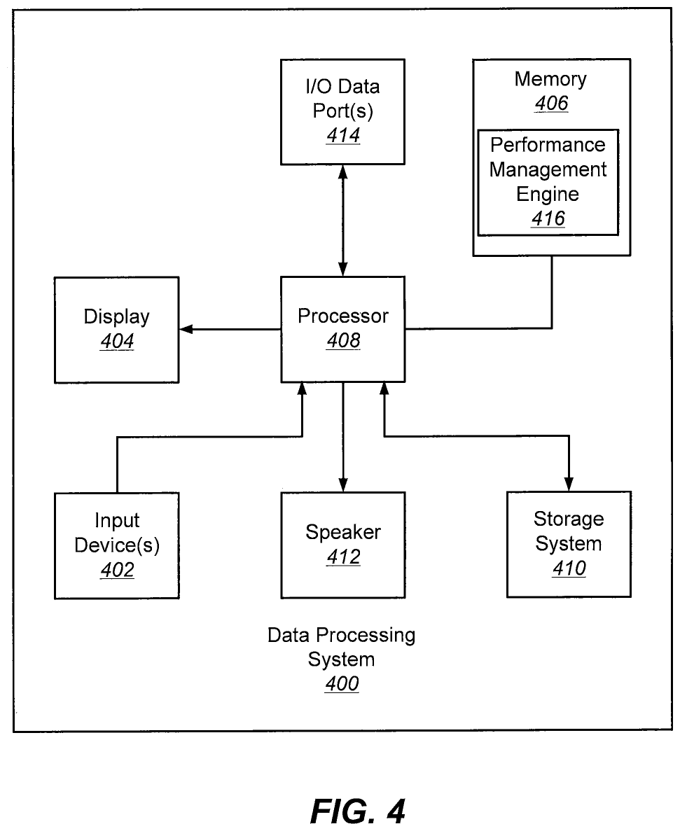

Referring now to FIG. 4, a data processing system 400 that may be used to implement the performance management system 200 of FIG. 2, in accordance with some embodiments of the inventive concept, comprises input device(s) 402, such as a keyboard or keypad, a display 404, and a memory 406 that communicate with a processor 408. The data processing system 400 may further include a storage system 410, a speaker 412, and an input/output (I/O) data port(s) 414 that also communicate with the processor 408. The storage system 410 may include removable and/or fixed media, such as floppy disks, ZIP drives, hard disks, or the like, as well as virtual storage, such as a RAMDISK. The I/O data port(s) 414 may be used to transfer information between the data processing system 400 and another computer system or a network (e.g., the Internet). These components may be conventional components, such as those used in many conventional computing devices, and their functionality, with respect to conventional operations, is generally known to those skilled in the art. The memory 406 may be configured with a performance management engine module 416 that may provide functionality that may include, but is not limited to, dynamic loading of an agent into a running process through runtime environment modification in accordance with some embodiments of the inventive concept.

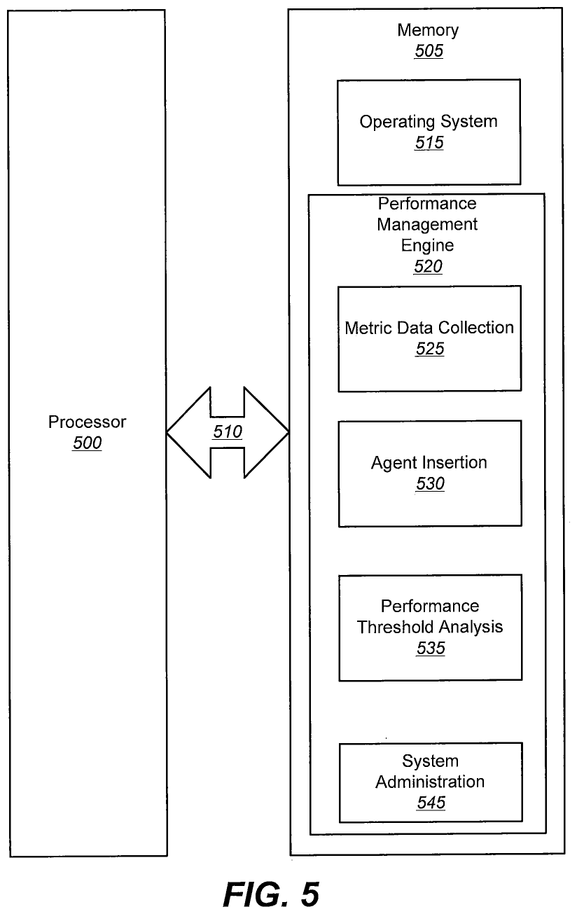

FIG. 5 illustrates a processor 500 and memory 505 that may be used in embodiments of data processing systems, such as the performance management system 200 of FIG. 2 and the data processing system 400 of FIG. 4, respectively, for dynamic loading of an agent into a running process through runtime environment modification in accordance with some embodiments of the inventive concept. The processor 500 communicates with the memory 505 via an address/data bus 510. The processor 500 may be, for example, a commercially available or custom microprocessor. The memory 505 is representative of the one or more memory devices containing the software and data used for dynamic loading of an agent into a running process through runtime environment modification in accordance with some embodiments of the inventive concept. The memory 505 may include, but is not limited to, the following types of devices: cache, ROM, PROM, EPROM, EEPROM, flash, SRAM, and DRAM.

As shown in FIG. 5, the memory 505 may contain two or more categories of software and/or data: an operating system 515 and a performance management engine module 520. In particular, the operating system 515 may manage the data processing system's software and/or hardware resources and may coordinate execution of programs by the processor 500. The performance management engine module 520 may comprise a metric data collection module 525, an agent insertion module 530, a performance threshold analysis module 530, and a system administration module 545.

The metric data collection module 525 may be configured to communicate with one or more entities in a computer system or communication network to collect performance data for one or more system performance metrics. The performance data may be associated with a variety of different performance metrics that may include, but are not limited to, for example, a count of a number of communication interfaces, an amount of installed memory, a memory utilization, a percentage of time devoted to memory garbage collection, a count of virtual machines running on a hypervisor, a processor utilization, an interface utilization, a number of Hypertext Transfer Protocol (HTTP) requests, and the like. The HTTP requests may be indicative of the amount of traffic being serviced by an application server, for example, such as traffic corresponding to customer requests, inquiries, searches, and the like.

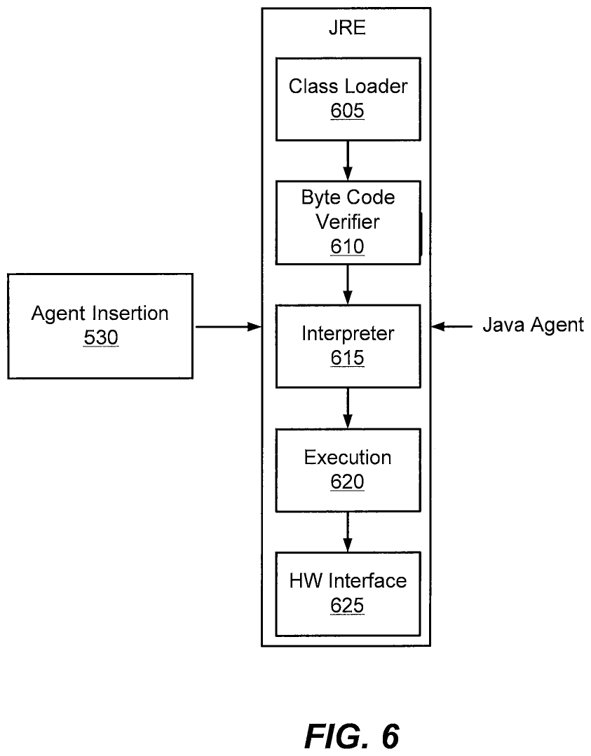

As described above, an enterprise owner of a deployed or active computing system and/or communication network may prefer to avoid taking their computer systems and/or networks offline to install performance monitoring software on the computing and/or network entities. Such an installation typically involves a restart of services after loading the new software, which may be costly in terms of economics, convenience, and the like. The agent insertion module 530 may be configured to facilitate the insertion of a Java agent into a running process on a computer system, network element, or the like through modification of the JRE of a process to include a new loader. In some embodiments, the agent insertion module 530 may be configured to cooperate with one or more software debugging tools and/or application programming interfaces to insert the loader. The JRE can be modified across container boundaries and/or username boundaries. For example, the JRE corresponding to a second process can be modified across container boundaries to include a new loader using a first process associated with a first user, such as a superuser, e.g., root, administrator, etc. When the JRE executes the loader it will load the Java agent into the second process, which may be associated with a second user different from the first user. Similarly, an agent insertion process associated with a first process corresponding to a first user may be used to modify the JRE corresponding to a second process associated with a second user irrespective of the use of any software container. The inserted Java agent may be used to collect information associated with performance metrics from one or more entities. FIG. 6 is a block diagram that illustrates the modification of a runtime environment, such as a JRE, in accordance with some embodiments of the inventive concept. Referring to FIG. 6, the JRE is an installation package, which provides an environment to run or execute a Java program or application on a processor. The JRE includes the Java Virtual Machine (JVM), which is responsible for executing the Java program line by line. As a result, the JVM may be viewed as an interpreter. The agent insertion module 530 modifies the JRE to include a loader 605 to load a Java agent. At runtimes, the class loader 605 loads all of the classes needed for the execution of a program including the Java agent and provides security by separating the namespaces of the local file system from that imported through the network. These files are loaded either from a hard disk, a network or from other sources. The byte code verifier 610 ensures that the code adheres to the JVM specification and does not violate system integrity. The byte code is loaded, checked, and run by the interpreter 615. The code is executed at block 620 on a hardware interface 625 through the interpreter 615 making the appropriate calls to the underlying hardware. Thus, a Java agent may be loaded into a running process through modification of a JRE associated with the running process to include a loader for loading the Java agent inside the running JRE.

The performance threshold analysis module 535 may be used to establish thresholds for the various metrics and to use these thresholds in evaluating performance information collected for the respective metric(s) for the various entities. The performance threshold analysis module 535 may be further configured to receive the performance information collected by the metric data collection module 525 and compare the performance information collected for the respective metric(s) for the various entities with the various thresholds defined for the entities, e.g., network elements, computer servers, software application, and the like.

The system administration module 545 may be configured to modify the configuration and/or other characteristic of one or more entities for which performance information has been collected.

Although FIG. 5 illustrates hardware/software architectures that may be used in data processing systems, such as the performance management system 200 of FIG. 2 and the data processing system 400 of FIG. 4, respectively, for dynamic loading of an agent into a running process through runtime environment modification in accordance with some embodiments of the inventive concept, it will be understood that the present invention is not limited to such a configuration but is intended to encompass any configuration capable of carrying out operations described herein.

Computer program code for carrying out operations of data processing systems discussed above with respect to FIGS. 1-6 may be written in a high-level programming language, such as C and/or C++, for development convenience. In addition, computer program code for carrying out operations of embodiments of the present invention may also be written in other programming languages, such as, but not limited to, interpreted languages. Some modules or routines may be written in assembly language or even micro-code to enhance performance and/or memory usage. It will be further appreciated that the functionality of any or all of the program modules may also be implemented using discrete hardware components, one or more application specific integrated circuits (ASICs), or a programmed digital signal processor or microcontroller.

Moreover, the functionality the performance management system 200 of FIG. 2, the data processing system 400 of FIG. 4, and the hardware/software architecture of FIG. 5, may each be implemented as a single processor system, a multi-processor system, a multi-core processor system, or even a network of stand-alone computer systems, in accordance with various embodiments of the inventive subject matter. Each of these processor/computer systems may be referred to as a “processor” or “data processing system.”

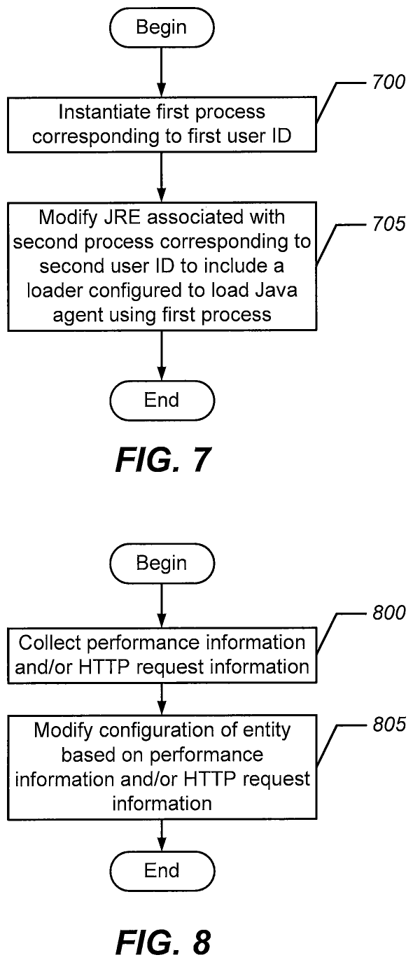

The data processing apparatus of FIGS. 1-6 may be used to facilitate the dynamic loading of an agent into a running process through runtime environment modification according to various embodiments described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 406 coupled to the processor 408 and the memory 505 coupled to the processor 500 include computer readable program code that, when executed by the respective processors, causes the respective processors to perform operations including one or more of the operations described and illustrated herein with respect to FIGS. 7 and 8.

FIG. 7 is a flowchart that illustrates dynamic loading of an agent into a running process through runtime environment modification in accordance with some embodiments of the inventive concept. Operations begin at block 700 where a first process is instantiated corresponding to a first user ID. The first process may be, for example, associated with a superuser, such as an administrator, through use of the system administration module 545 and/or the metric data collection module 525. At block 705, the JRE associated with a second process corresponding to a second user ID is modified by way of the agent insertion module 530 associated with the first process to include a loader configured to load a Java agent into the second process. Thus, a Java agent may be loaded into a running process without the need to reboot or restart the process as the JRE corresponding to the running process loads the Java agent through the loader that has been inserted into the JRE.

In some embodiments, the loader may comprise a shared library that is injected into the target process, which starts a new thread. This thread may then load another shared library called “libinstrument.so,” which calls an exposed symbol (a function name within libinstrument.so that can be called by all within that target process) by the name of Agent_onAttach to which an agent jar file is passed. The shared library may, in some embodiments, be injected through “hotpatching,” which may use “ptrace” to facilitate the injection.

As described above, the Java agent may be used to collect performance information associated with an entity, such as a computer system, network equipment device, software component, e.g., application, and the like. Referring to FIG. 8, operations begin at block 800 where the metric data collection module 525 collects performance information and/or HTTP request information using the Java agent that has been inserted. The performance information may be associated with a variety of different performance metrics that may include, but are not limited to, for example, a count of a number of communication interfaces, an amount of installed memory, a memory utilization, a count of virtual machines running on a hypervisor, a processor utilization, and an interface utilization. At block 805, the system administration module 545 may modify the configuration of one or more entities based on the performance information and/or the HTTP request information to improve the operation and/or performance of the entities individually or as part of a larger computing system and/or network.

Embodiments of the inventive concept may allow a JRE to be modified with a loader that initiates a Java agent load or bootstrap from within the JRE. As a result, a Java agent can be loaded into a running process across both container and username boundaries. This may allow performance monitoring software, for example, to monitor and collect performance information on containerized microservices or, in other examples, have a single universal agent loader that bootstraps a Java agent into all services running on a given host and/or all containerized applications. Advantageously, Java agent insertion into a running process, according to some embodiments of the inventive concept, may be achieved without any modification of a Java application startup script and subsequent restart or reinitialization of the Java application, which involves downtime of one or more systems and/or services that may have economic, security, safety, or other types of unwanted ramifications. In addition, a configuration of an entity may be modified based on the performance information that is collected using the Java agent to improve the performance, reliability, quality of service, and the like of the entity itself or the overall system or network of which the entity is a part.

### Further Definitions and Embodiments

In the above-description of various embodiments of the present disclosure, aspects of the present disclosure may be illustrated and described herein in any of a number of patentable classes or contexts including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items. Like reference numbers signify like elements throughout the description of the figures.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

What is claimed is:

1. A method, comprising:
performing by a processor:
instantiating a first process corresponding to a first user identification; and
modifying a Java Runtime Environment (JRE) associated with a second process corresponding to a second user identification that is different from the first user identification to include a loader, the loader being configured to load a Java agent into the second process;
wherein modifying the JRE comprises modifying the JRE using the first process.

2. The method of claim 1, wherein the first process is in a container and the second process is outside of the container.

3. The method of claim 2, wherein the container is a first container and the second process is in a second container.

4. The method of claim 1, wherein the second user identification corresponds to a superuser account used for administrative functions.

5. The method of claim 1, wherein the Java agent is configured to collect performance information corresponding to an entity for a performance metric.

6. The method of claim 5, wherein the performance metric comprises a count of a number of communication interfaces, an amount of installed memory, a memory utilization, a percentage of time devoted to memory garbage collection, a processor utilization, or an interface utilization.

7. The method of claim 5, wherein the entity comprises a hardware element.

8. The method of claim 7, wherein the hardware element comprises a switch, a router, or an application server.

9. The method of claim 5, wherein the Java agent is further configured to collect information corresponding to Hypertext Transfer Protocol (HTTP) requests associated with the second process.

10. The method of claim 5, further comprising:
modifying a configuration of the entity based on the performance information.

11. A system, comprising:
a processor; and
a memory coupled to the processor and comprising computer readable program code embodied in the memory that is executable by the processor to perform operations comprising:
instantiating a first process corresponding to a first user identification;
modifying a Java Runtime Environment (JRE) associated with a second process corresponding to a second user identification that is different from the first user identification to include a loader, the loader being configured to load a Java agent into the second process, the Java agent being configured to collect performance information corresponding to an entity for a performance metric; and
modifying a configuration of the entity based on the performance information
wherein modifying the JRE comprises modifying the JRE using the first process.

12. The system of claim 11, wherein the first process is in a container and the second process is outside of the container.

13. The system of claim 12, wherein the container is a first container and the second process is in a second container.

14. The system of claim 11, wherein the performance metric comprises a count of a number of communication interfaces, an amount of installed memory, a memory utilization, a percentage of time devoted to memory garbage collection, a processor utilization, or an interface utilization.

15. The system of claim 11, wherein the Java agent is further configured to collect information corresponding to Hypertext Transfer Protocol (HTTP) requests associated with the second process.

16. A computer program product, comprising:
a tangible computer readable storage medium comprising computer readable program code embodied in the medium that when executed by a processor causes the processor to perform operations comprising:
instantiating a first process corresponding to a first user identification; and
modifying a Java Runtime Environment (JRE) associated with a second process corresponding to a second user identification that is different from the first user identification to include a loader, the loader being configured to load a Java agent into the second process, the Java agent is configured to collect information corresponding to Hypertext Transfer Protocol (HTTP) requests associated with the second process;
wherein modifying the JRE comprises modifying the JRE using the first process.

17. The computer program product of claim 16, wherein the Java agent is further configured to collect performance information corresponding to an entity for a performance metric.

18. The computer program product of claim 17, wherein the performance metric comprises a count of a number of communication interfaces, an amount of installed memory, a memory utilization, a percentage of time devoted to memory garbage collection, a processor utilization, or an interface utilization.

19. The computer program product of claim 17, wherein the entity comprises a hardware element.

20. The computer program product of claim 17, wherein the operations further comprise:
modifying a configuration of the entity based on the performance information.
